(19) United States
(12) Patent Application Publication
(10) Pub. No.: US 2003/0108108 A1
(43) Pub. Date: Jun. 12, 2003

(54) Decoder, decoding method, and program distribution medium therefor

(76) Inventors: Takashi Katayama, Hirakata City (JP); Masaharu Matsumoto, Katano City (JP)

Correspondence Address: SMITH PATENT OFFICE, 1901 PENNSYLVANIA AVENUE N W, SUITE 200, WASHINGTON, DC, 20006

(21) Appl. No.: 10/291,752

(22) Filed: Nov. 12, 2002

(30) Foreign Application Priority Data
Nov. 15, 2001 (JP) 2001-349949

(51) Int. Cl. H04B 14/06

(52) U.S. Cl. 375/245

(57) ABSTRACT

A time domain signal is converted into a frequency domain signal, and an encoded bit stream is provided. A bit stream decomposer decodes bit stream information, and a storage unit temporary stores the information. In accordance with the bit stream information, a spectral expander expands a frequency spectrum quantized inverse by in an inverse quantizer up to an integer multiple of a sampling frequency of the bit stream. A frequency-time domain converter converts the frequency spectrum into a time domain signal. Thereby, harmonics can precisely be implemented with a small amount of processing, and the band can be expanded with less distortion.

### BACKGROUND OF THE INVENTION

1. Field of the Invention

The present invention relates to a decoder which reproduces an encoded acoustic signal to a time domain signal with an arbitrary sampling frequency to output the resultant signal, a decoding method, and a program distribution medium containing an operation program of the decoding method.

2. Description of Related Art

Hereinafter, a technique relative to a decoder for reproducing an encoded acoustic signal to a time domain signal with an arbitrary sampling frequency to output the resultant signal will be described with reference to FIGS. 1 to 5. In recent years, electronic music delivery has been started through networks such as the Internet and telephone lines, and high-efficiency compressed and encoded music of various types is distributed to homes through various methods. In an electric music delivery system, music data is stored in a distribution server. A user once performs downloading all the music data via a network or streaming, and then transfers the music data to an own user terminal.

In many cases, a server contains pay data for sale and data primarily intended for pre-listening. Ordinary pay data for sale usually has audio quality of a level equivalent to that of a CD (compact disk), a sampling frequency of about 44.1 kHz, and a bit ratio of about 128 kbps.

In the case of pre-listening data, when performing real-time downloading and streaming for pre-listening, the bit ratio is dependent on the network. In particular, to transmit music information through a network using a PHS, since the bandwidth is limited to about 64 kbps at maximum, a usable bit ratio is hence limited to only about 32 kbps. In this case, the sampling frequency is reduced lower than the pay data, and the data is thereby encoded. Hereinafter, operation of a conventional decoder will be described referring to an instance where original data has a sampling frequency of 44.1 kHz, and sampling data has a sampling frequency of 16 kHz.

With the sampling frequency of 16 kHz, since the band is narrower than the band that with 44.1 kHz, a furry sound is produced. In the present decoder, the following methods can be considered:

1) The data is at the sampling frequency remained unchanged;

2) Up-sampling is performed, and the data is reproduced at a higher sampling frequency; and

3) Up-sampling is performed, information is added to a higher band, and the band is thereby quasi-widened.

Hereinafter, the case 3) where the band is widened will be described. In the case, description will be given with reference to decoding processing of MPEG-2 advanced audio coding (AAC). FIG. 1 is a block diagram showing the configuration of the conventional decoder. An input bit stream encoded with the sampling frequency of 16 kHz is inputted through a bit stream input unit 1 and is then analyzed by a bit stream decomposer 2. Then, the bit stream information is stored into a storage unit 3. The bit stream information contains information, such as information composing a frequency spectrum and information of a sampling frequency fₛ.

An inverse quantizer 5 generates a spectral signal in a frequency band in units of a channel according to the obtained bit stream information. A frequency-time domain converter 7 converts the spectral signal into a time domain data. The signal converted into the time domain signal in units of a channel is supplied to a sampling frequency converter 9. The sampling frequency converter 9 converts the sampling frequency and outputs a time signal 8 in accordance with a command received from an external frequency information input unit 4. In the particular example, two times as high as the original one is shown by the input unit 4.

FIG. 2 shows a configuration of a sampling frequency converter 9. The sampling frequency converter 9 is configured to include a sample hold circuit 11 and a filtering unit 12. FIG. 3 shows an example characteristic of the filtering unit 12, and FIG. 4 shows an example configuration of the filtering unit 12. The filtering unit 12 is configured to include delaying devices 13a to 13d, multipliers 14a to 14e and an adder 15. The filtering unit 13 has the function of an IIR filter. The filter has a characteristic of a low pass filter in which, as shown in FIG. 3, when fₛ represents the sampling frequency of encoded data, the gain gradually decreases in a range of from fₛ/2 to fₛ.

The time-domain signal inputted to the sampling frequency converter 9 is converted and then inputted to the sample hold circuit 11 shown in FIG. 2. The signal spectrum of the input signal of the sample hold circuit 11 is assumed as that shown in FIG. 5A. In the sample hold circuit 11, upon receipt of one sample input, the sampling frequency thereof is increased two times as high as that of input, and two sample outputs are thereby generated each of which is the same as the input. Consequently, the signal spectrum changes as shown in FIG. 5B. FIG. 5B shows that the spectrum is horizontally symmetric with respect to the ½ fₛ as the center.

The signal having the spectrum shown in FIG. 5B is inputted to the filtering unit 12. In the filtering unit 12, the high-band component is attenuated, as shown in FIG. 3. According to these operations, a high-band component is added, and the reproducing spectrum can be widened.

As described above, according to the conventional method, an acoustic signal is returned to a time-domein waveform, a sampling frequency is converted, and a high-band component is thereby added. In this method, however, it is difficult calculate the high-band component with respect to components in a regular band, thereby making the sound distorted. When attempting to precisely predict the high-band component, the signal processing amount increases. As such, a decoder which enables a band expansion with a less amount of processing and less distortion is demanded.

### SUMMARY OF THE INVENTION

The present invention is made in view of the above-described problems. An object of the present invention is to realize a decoder and a decoding method that generate high-band frequency data by using spectral information obtained in a frequency-time conversion when an encoded signal is decoded, thereby enabling a reduction in the amount of processing and a reduction of distortion in an acoustic signal, and also provide a program distribution medium which contains an operation program for operating of the decoding method.

A decoder of the present invention comprises a bit stream input unit, a bit stream decomposer, a bit stream information storage unit, an inverse quantizer, a spectral expander, and an external frequency information input unit a frequency-time domain converter. The bit stream input unit inputs a bit stream obtained by encoding a frequency domain signal converted from a time domain signal. The bit stream decomposer analyzes a signal received from bit stream input unit and decodes bit stream information. The bit stream information storage unit temporarily stores the bit stream information obtained through bit stream decomposer. The inverse quantizer generates a frequency spectral signal in a predetermined frequency band in accordance with the bit stream information in bit stream information storage unit. The spectral expander outputs an expanded spectrum generated by adding a frequency spectrum in a band higher than predetermined frequency band to a frequency spectrum outputted from inverse quantizer. The external frequency information input unit which retrieves information of a sampling frequency of the bit stream from the bit stream information in bit stream information storage unit to determine a sampling frequency intended to be decoded. The frequency-time domain converter converts frequency spectral data outputted from spectral expander into a time domain signal in accordance with a sampling frequency received from external frequency information input unit.

### BRIEF DESCRIPTION OF THE DRAWINGS

FIG. 1 shows a configuration of a conventional decoder;

FIG. 2 shows a configuration of a sampling frequency converter using the conventional decoder;

FIG. 3 shows frequency characteristics of a filtering unit of a conventional sampling frequency converter;

FIG. 4 shows a configuration of the filtering unit used with the sampling frequency converter;

FIGS. 5A to 5C are spectral diagrams at the time of spectral expansion according to the conventional decoder;

FIG. 6 shows a configuration of a decoder according to an embodiment of the present invention;

FIGS. 7A and 7B are spectral diagrams at the time of spectral expansion according to the embodiment;

FIG. 8 illustrates harmonic components of frequency spectra according to the embodiment;

FIG. 9 is a flowchart showing operations at the time of spectral expansion according to the embodiment; and

FIG. 10 is a conceptual view showing values of a first harmonic and a second harmonic of the fundamental spectrum.

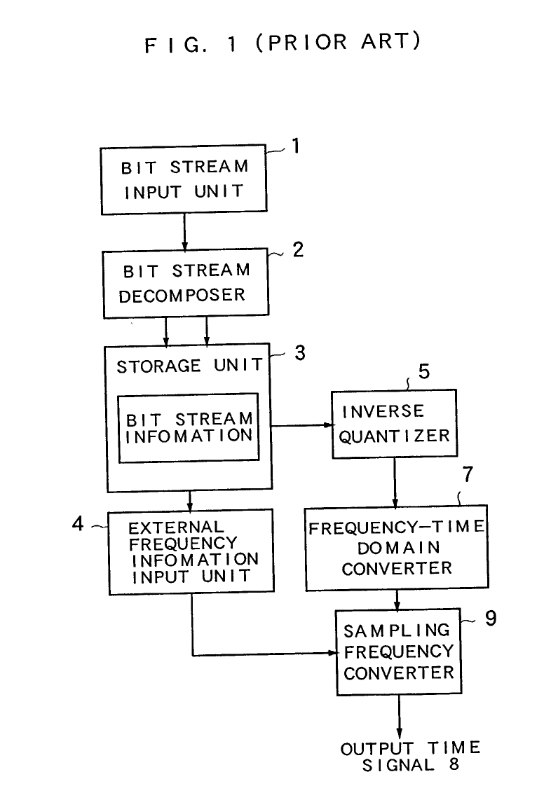

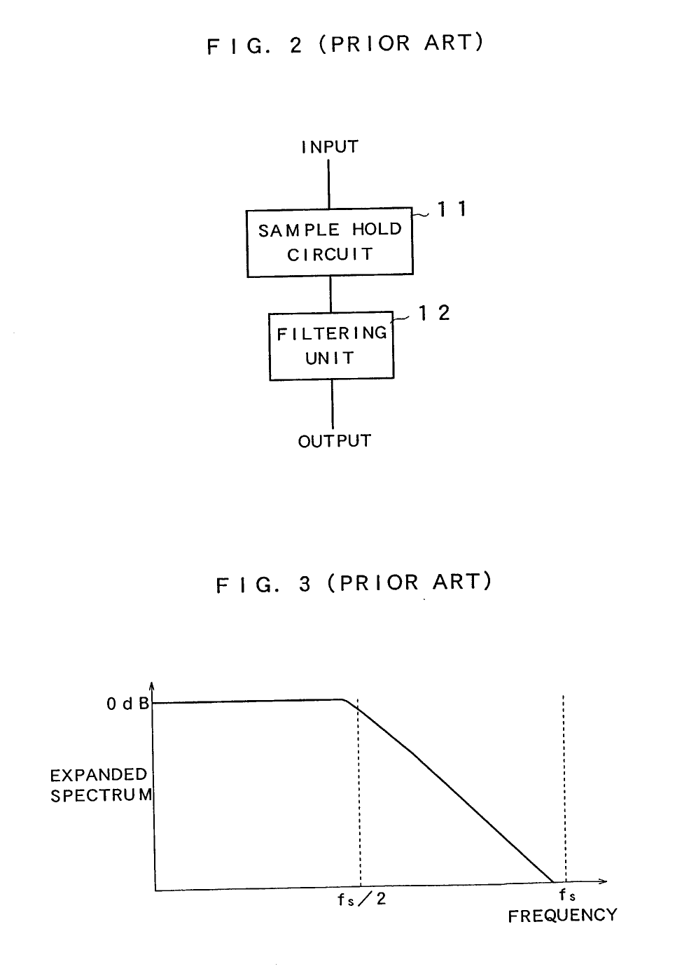

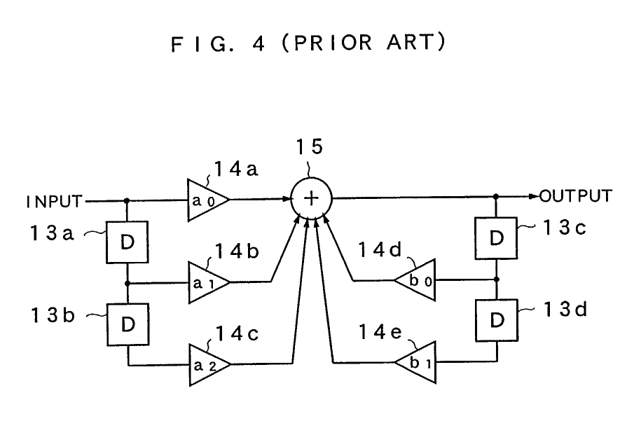

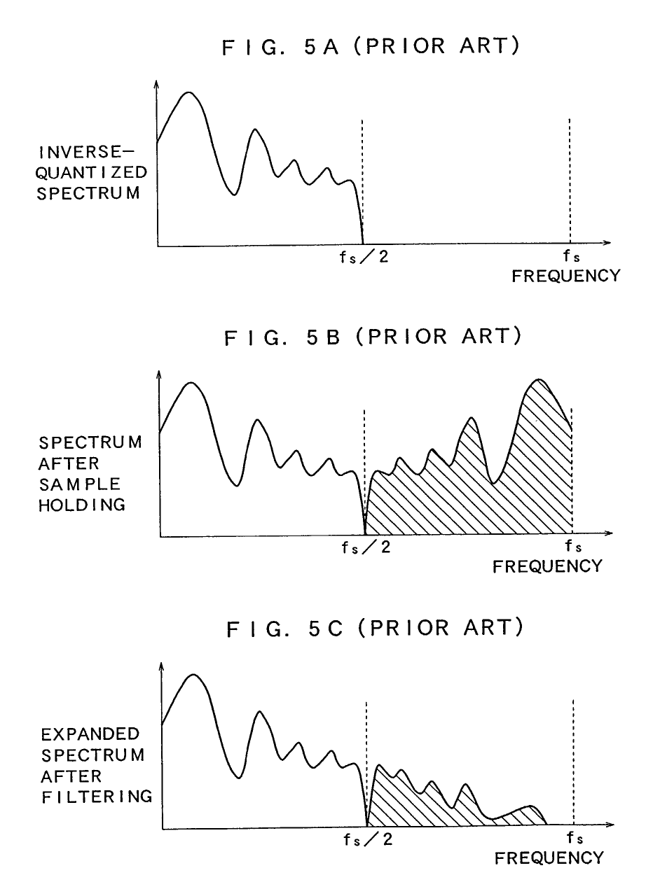

### DESCRIPTION OF THE PREFERRED EMBODIMENT

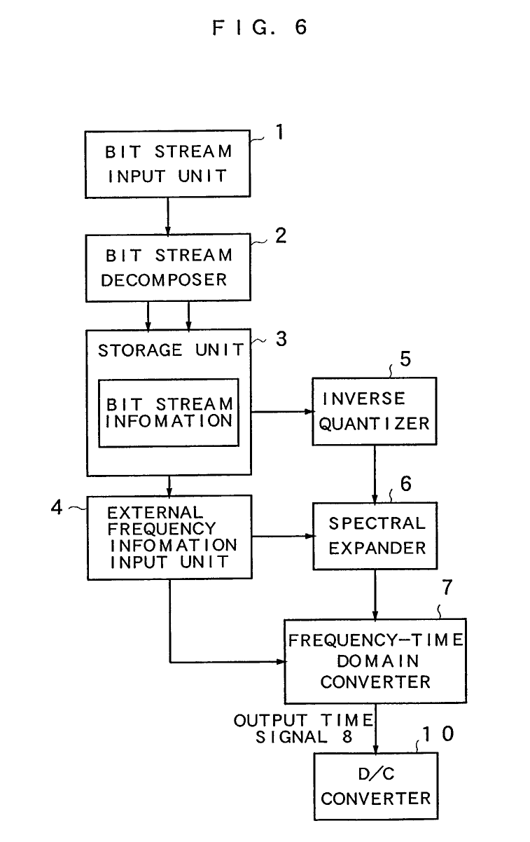

Hereinafter, a decoder and a decoding method according to an embodiment of the present invention will be described with reference to the drawings. FIG. 6 shows a configuration of a decoder according to the embodiment. The configuration will be described with reference to the same numerals for same blocks to those in the conventional example. The decoder of the present embodiment is configured to include a bit stream input unit 1, a bit stream decomposer 2, a storage unit 3, an external frequency information input unit 4, an inverse quantizer 5, a spectral expander 6, and a frequency-time domain converter 7.

The bit stream input unit 1 inputs a bit stream obtained by encoding a signal generated by converting a time domain signal into a frequency domain signal. The bit stream decomposer 2 analyzes a signal received from the bit stream input unit 1, and then decodes bit stream information. The storage unit 3 works as a bit stream information storage unit which temporarily stores the bit stream information obtained by the bit stream decomposer 2. The inverse quantizer 5 generates a frequency spectral signal in a predetermined frequency band in accordance with the bit stream information stored in the storage unit 3. The spectral expander 6 adds a frequency spectrum higher than a predetermined frequency band to the frequency spectrum that has been outputted from the inverse quantizer 5, and outputs an expanded spectrum. The external frequency information input unit 4 retrieves information of the sampling frequency information of the bit stream from the bit stream information temporarily stored in the storage unit 3, and determines a sampling frequency required to be decoded. The frequency-time domain converter 7 converts the frequency spectral outputted from the spectral expander 6 into a time domain signal (time signal) in accordance with the sampling frequency received from the external frequency information input unit 4. A D/A converter 10 for converting the time domain signal into an analog signal is provided in a latter stage of the decoder. The input unit 4 preferably selects one of sampling rates operable for the D/A converter 10.

Hereinafter, operation of the decoder of the embodiment will be described. An input bit stream of an acoustic signal is analyzed in the bit stream decomposer 2, and bit stream information is stored into the storage unit 3. The bit stream information includes, for example, information composing a frequency spectrum, and information of, for example, sampling frequency of the bit stream. The bit stream information is supplied to the input unit 4 and the inverse quantizer 5.

The inverse quantizer 5 receives the bit stream information, and generates a frequency spectral signal. Upon receipt of the bit stream information, the input unit 4 outputs an magnification factor (MF) to the spectral expander 6 and the frequency-time domain converter 7 in accordance with an output sampling frequency inputted from the system and the sampling frequency of the bit stream.

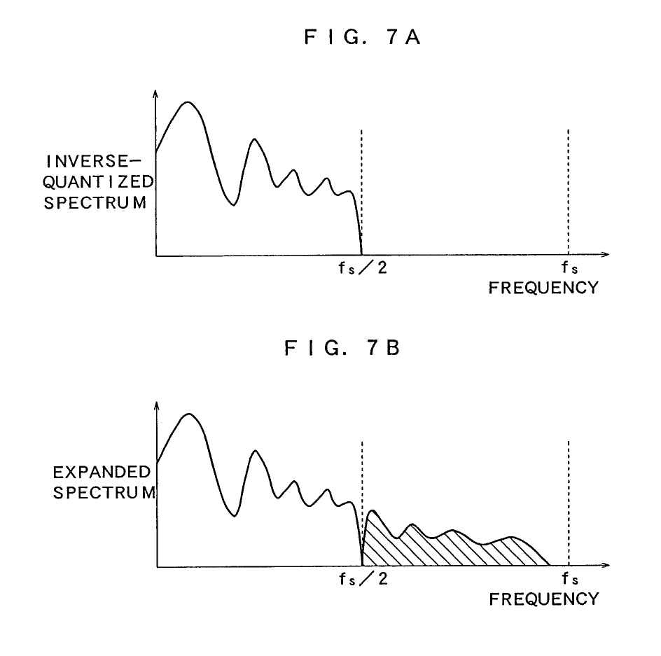

The spectral expander 6 generates high band information of the spectrum according to the information from the input unit 4. FIG. 7A shows an example of inputted data to the spectral expander 6. A band occupied by the inputted data is referred to as an “in-band spectrum”. For the data shown in FIG. 7A, in accordance with the magnification factor, a storage area is reserved to store high-band spectral data not contained in the bit stream. This high-band spectrum is referred to as an “out-of-band spectrum”.

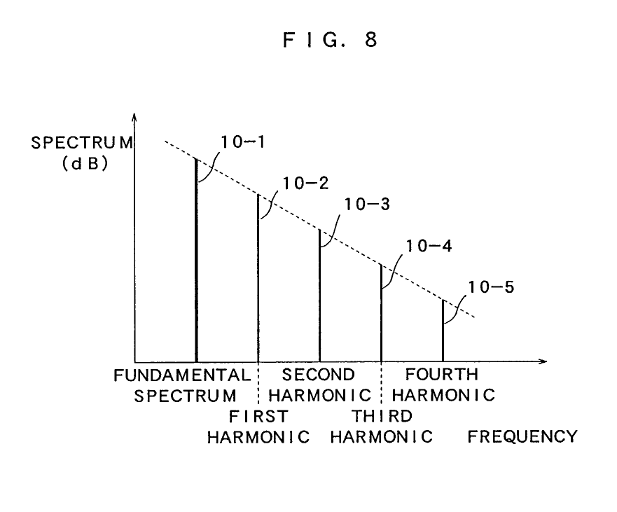

When the magnification factor is 2, an area needs to be as large as an area sufficient to store the spectrum of the sampling frequency of the bit stream. When the magnification factor is 4, an area needs to be three times as large as the area sufficient to store the spectrum of the sampling frequency of the bit stream. Preferably, the spectral magnification factor is an integer multiple of the n-th power of 2 (n=natural number greater than 0), such as two or four times of a sampling frequency fₛ. Thereby, a harmonic spectrum can easily be calculated using a fast Fourier transform. The reserved expansion area is initialized with 0. Subsequently, high band spectrum is generated from the spectrum shown in FIG. 7A, and is then stored. FIG. 8 shows an example method of generating high band information. This method predicts harmonic components from the fundamental spectrum obtained from the inverse quantizer 5.

With respect to a fundamental spectrum (10-1) shown in FIG. 8, the method predicts first to fourth harmonic spectra (10-2, 10-3, . . . , 10-5) according to a predetermined rule (function). In terms of the frequency of the harmonic spectrum, the first order corresponds to two times the fundamental spectrum, the second order corresponds to three times the fundamental spectrum, the three order corresponds to four times the fundamental spectrum, and the fourth order corresponds to five times the fundamental spectrum. The harmonic prediction method shown in FIG. 8 causes attenuations with constant attenuation factors k₁, k₂, k₃, . . . , as the harmonic order increases. Out-of-band spectra are calculated in this way.

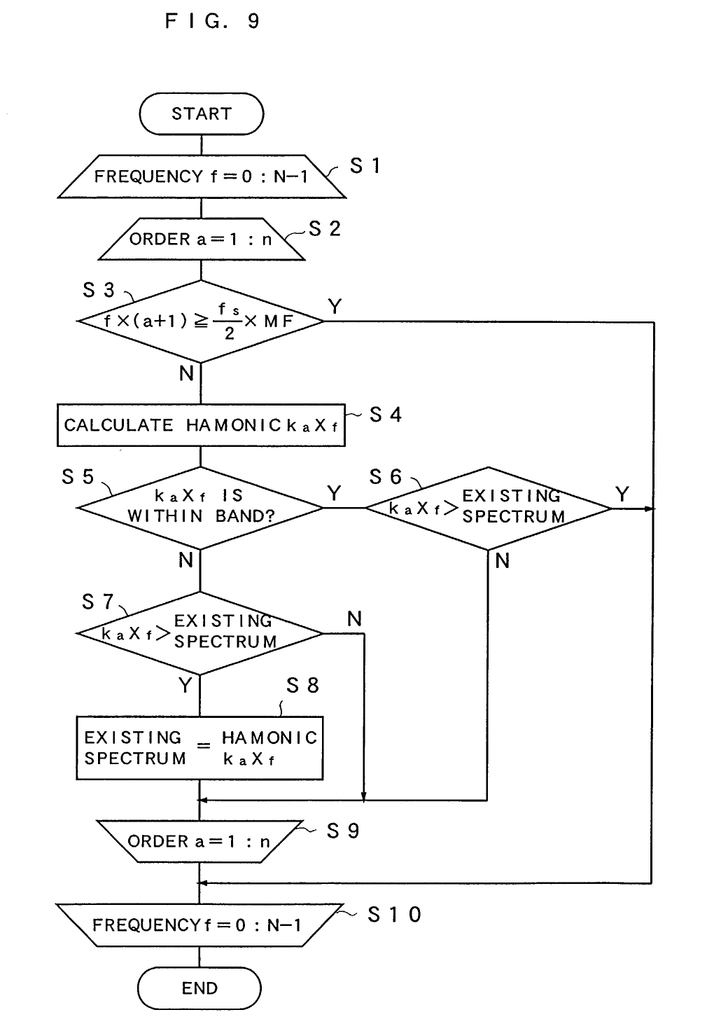

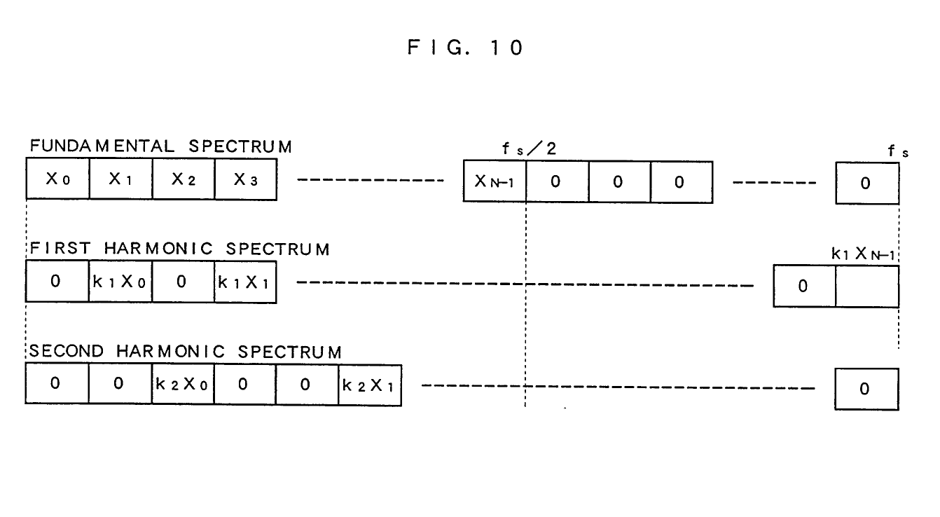

Hereinafter, referring to a flowchart shown in FIG. 9 and a spectral table shown in FIG. 10, a system of setting harmonics up to an n-th harmonic for each in-band spectrum will be described.

First, a first harmonic is calculated for each in-band spectrum. For the first harmonic, at step S1 a pointer f indicating the frequency is set to 0, and at step S2, an order a is set to 1. Subsequently, at step S3 the system of the embodiment determines as to whether the frequency to be calculated is within a range in which the fundamental frequency fₛ/2 is increased. If the harmonic is the first harmonic, any case falls within the given range. Hence, at step S4, the spectrum is set to a position of a twofold frequency, and the spectrum is expanded to have an intensity obtained by multiplying a predetermined attenuation factor k₁, that is, by performing determined a calculation of k₁Xf, as shown in FIGS. 8 and 10. For a spectrum in which the first harmonic is within the range of 0 to fₛ/2 at step S5, the system performs a comparison between the intensity of a first harmonic k₁X₀ and an in-band spectrum X₁ having the same frequency as that of the first harmonic at step S6. If the in-band spectrum X₁ is greater than or equal to the first harmonic k₁X₀, the process proceeds to step S9, and the system calculates a subsequent-order harmonic in that state. If the in-band spectrum X₁ is less than the first harmonic k₁X₀, the process proceeds to step S10. Thereafter, the system ceases a calculation of the subsequent-order harmonic, and performs processing for a subsequent frequency.

For a spectrum in which a first harmonic exists outside of the fundamental band, at step S7 the system performs a comparison between the intensity of the first harmonic k₁X₀ and that of an existing out-of-band spectrum having the same frequency as that of the first harmonic. When calculating the first harmonic, the intensity of existing out-of-band spectrum is less than that of the harmonic. Hence, at step S8 the system replaces the existing out-of-band spectrum with the first harmonic. Then at the next step S9, the system calculates a subsequent-order harmonic in that state.

Subsequently, the system performs a calculation of a second harmonic. The second harmonic, is a spectrum having the intensity of a predetermined attenuation of the fundamental spectrum as shown in FIG. 8, at a threefold frequency position as shown in FIG. 10, and the attenuation factor being set to K₂.

In step S3, when the second harmonic exists at a frequency greater than or equal to the magnification factor of the sampling frequency, i.e., fₛ or greater in the present case, no subsequent calculations are performed.

For a spectrum of second harmonic is within the fundamental band, the process proceeds from step S5 to step S6, the system performs a comparison between the intensities of a second harmonic k₂X₀ and an in-band spectrum X₂ having the same frequency as that of the second harmonic. If the in-band spectrum X₂ is greater than or equal to the second harmonic k₂X₀, the process proceeds to step S9, and the system calculates a subsequent-order harmonic in that state. If the in-band spectrum X₂ is less than the second harmonic k₂X₀, the process proceeds to step S10. Thereafter, the system ceases a calculation of the subsequent-order harmonic.

For a spectrum of second harmonic is outside of the fundamental band, at step S7 the system performs a comparison between the intensities of the second harmonic and an existing out-of-band spectrum having the same frequency as that of the second harmonic. If the existing out-of-band spectrum is less in intensity than the harmonic, at step S8 the system replaces the existing out-of-band spectrum with the second harmonic. If the existing out-of-band spectrum is greater than the second harmonic, the process then proceeds to step S9; and the system calculates a subsequent-order harmonic in that state.

Subsequently, calculation of harmonic is performed on and after third harmonic up to n-th harmonic as in the same manner as the calculation of the second harmonic. Each of the harmonics having frequencies of from 0 to N−1 is obtained by the abovementioned method. Thereby, the out-of-band spectrum is formed as shown in FIG. 7B.

Hereinafter, another method of setting the harmonics up to the n-th harmonic to each in-band spectrum will be described. First, a first harmonic is calculated. When the sampling frequency is represented by fₛ, the first harmonic is set to a spectrum formed such that each in-band spectrum is shifted to a twofold frequency, i.e., a position of fₛ/2 to fₛ. The spectrum has a intensity after the predetermined attenuation as shown in FIG. 8 is performed. As such, the first harmonic is set to a spectrum having a ½ to ¼ fₛ of the bit stream.

Subsequently, a second harmonic is calculated. The second harmonic is a spectrum formed such that each in-band spectrum is shifted to a threefold frequency, i.e., a position of fₛ/2 to fₛ. The spectrum has a intensity after the predetermined attenuation as shown in FIG. 8 is performed. As such, the second harmonic is set to a spectrum having a ⅓ to ⅙ fₛ of the bit stream.

When a first harmonic is already set to a spectrum in a frequency range of ⅓ to ¼ fₛ of the bit stream, relatively great one of the individual harmonics is set. A first harmonic is calculated for a spectrum in a frequency range of ¼ to ⅙fₛ of the bit stream. When a first harmonic is greater than a currently existing in-band spectrum, a calculation of a second harmonic is not performed.

Thus, the harmonics up to the n-th order are obtained according to the method in which when a low-order harmonic does not exist, no calculation is performed for a harmonic of an order higher than the order. Thereby, the out-of-band spectrum is formed as shown in FIG. 7B.

Upon receipt of the frequency spectrum obtained as described above and magnification factor information outputted from the external frequency information input unit 4, the frequency-time domain converter 7 converts the spectrum into a time domain signal. When the magnification factor is 1, a conversion expression in the frequency-time domain converter 7 is an equation (1) shown below according to MPEG-2 AAC. In the present embodiment, while a description is provided regarding a time-domain signal xₙ in the case of a LONG block (frame length: 1024), it is similar in other relevant cases.

$${X}_{n} = {\sum }_{k = 0}^{N - 1} {X}_{k} cos [ \frac{2 π}{N} ( n + {n}_{0} ) ( k + \frac{1}{2} ) ] \qquad ( 1 )$$

In the above expression, n is a variable in a range of from 0 to N−1, and represents the sequence from the top of frame of the time-axis information. In AAC, N is 128 in the case SHORT bocks and is 1024 in others. N₀is (N/2+1)/2. Xₖ represents a k-th value among N spectra.

When the magnification factor is 2, N is replaced with a value multiplied by the magnification factor 2. That is, it is replaced with 2N.

As a result, the conversion expression is changed as follows:

$${X}_{n} = {\sum }_{k = 0}^{2 N - 1} {X}_{k} cos [ \frac{π}{N} ( n + {n}_{0} ) ( k + \frac{1}{2} ) ] \qquad ( 2 )$$

In the above, n varies from 0 to 2N−1.

In comparison to equation (1), equation (2) is characterized in that the accumulation counts are increased twice, and the cosine table steps are decreased half. This indicates that when the cosine table of equation (2) is built into the apparatus, the read interval of the cosine table may be set to be skipped in order to execute equation (1).

Thus, preparation of a parameter table, that is, a maximum magnification factor table, necessary for the conversion operation of maximum integer multiples, enables operations of all the magnification factors to be implemented. The method of the frequency-time conversion corresponding to the magnification factor enables the reproduction of an acoustic signal with a band expanded according to the sampling frequency inputted from input unit 4. In addition, the input unit 4 automatically selects one of inputtable sampling rates of the D/A converter mounted to the decoder.

With each of the expressions shown above, a high-speed algorithm is established. As such, the operation can be implemented with a small amount of processing. Specifically, the operation can be implemented with about 2 MIPS when N=1024 and the sampling frequency=16 kHz, and the operation can be implemented with about 4 MIPS when the magnification factor=2. The above-described processes enable the realization of the decoder with which the harmonics can precisely be implemented with a small amount of processing, and the band can be expanded with less distortion.

A time domain signal is converted into a frequency domain signal, a bit stream obtained by encoding is analyzed, bit stream information is decoded, and the information is inverse-quantized. Thereafter, a frequency spectrum is expanded up to an integer multiple of a sampling frequency of the bit stream, a high-band frequency spectrum not included in the bit stream is predicted according to harmonic components, a frequency spectrum to which the predicted high-band frequency spectrum is added is converted into time data. These processes enable the realization of the decoder and the decoding method with which the harmonics can precisely be implemented with a small amount of processing, and the band can be expanded with less distortion. Furthermore, the decoding method is recorded into a program distribution medium, thereby enabling the method to be implemented with the provided decoder.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese priority application no. 2001-349949 filed on Nov. 15, 2001 is hereby incorporated by reference.

What is claimed is:

1. A decoder comprising:
a bit stream input unit which inputs a bit stream obtained by encoding a frequency domain signal converted from a time domain signal;
a bit stream decomposer which analyzes a signal received from said bit stream input unit and which decodes bit stream information;
a bit stream information storage unit which temporarily stores the bit stream information obtained through said bit stream decomposer;
an inverse quantizer which generates a frequency spectral signal in a predetermined frequency band in accordance with the bit stream information in said bit stream information storage unit;
a spectral expander which outputs an expanded spectrum generated by adding a frequency spectrum in a band higher than said predetermined frequency band to a frequency spectrum outputted from said inverse quantizer;
an external frequency information input unit which retrieves information of a sampling frequency of the bit stream from the bit stream information in said bit stream information storage unit to determine a sampling frequency intended to be decoded; and
a frequency-time domain converter which converts frequency spectral data outputted from said spectral expander into a time domain signal in accordance with a sampling frequency received from said external frequency information input unit.

2. A decoder according to claim 1, wherein
said spectral expander expands the sampling frequency of the input bit stream to an integer multiple of the n-th power of 2 (n=natural number greater than 0).

3. A decoder according to claim 1, wherein
said frequency-time domain converter includes only a parameter table necessary for a conversion operation of an expandable maximum integer multiple of the sampling frequency.

4. A decoder according to claim 1, wherein
said external frequency information input unit automatically selects one of inputtable sampling rates of a D/A converter connected to the decoder.

5. A decoder according to claim 1, wherein
said spectral expander generates a harmonic spectrum in such a manner that a frequency spectral signal obtained from the input bit stream is expanded to an integer multiple of the n-th power of 2 in accordance with information received from said external frequency information input unit, and energy of high-band components up to a specified order is predicted by use of a predetermined function.

6. A decoder according to claim 5, wherein said spectral expander generates a harmonic spectrum in such a manner that when an out-of-band harmonic spectrum of a fundamental frequency is greater in intensity than an existing spectrum, and processing of replacing the fundamental spectrum with the harmonic spectrum is sequentially performed from a low-order.

7. A decoder according to claim 5, wherein said spectral expander performs spectral expansion in such a manner that when an in-band harmonic spectrum of a fundamental frequency is greater in intensity than an existing spectrum, processing of terminating operation of a subsequent higher order.

8. A decoder according to claim 5, wherein said predetermined function has characteristics in that harmonic-spectrum energy is reduced as the harmonic order increases.

9. A decoding method comprising the following steps of:
a bit stream input step of inputting a bit stream obtained by encoding a frequency domain signal converted from a time domain signal;
a bit stream decomposing step of analyzing a signal received from said bit stream input unit and of decoding bit stream information;
a bit stream information storing step of temporarily storing the bit stream information obtained through said bit stream decomposing step;
an inverse quantizing step of generating a frequency spectral signal in a predetermined frequency band in accordance with the bit stream information in said bit stream information storing step;
a spectral expanding step of outputting an expanded spectrum generated by adding a frequency spectrum in a band higher than said predetermined frequency band to a frequency spectrum outputted from said inverse quantizing step;
an external frequency information inputting step of retrieving information of a sampling frequency of the bit stream from the bit stream information in said bit stream information storing step to determine a sampling frequency intended to be decoded; and
a frequency-time domain converting step of converting frequency spectral data outputted from said spectral expanding step into a time domain signal in accordance with a sampling frequency received from said external frequency information inputting step.

10. A program distribution medium to which a decoding method is written in the form of a program comprising:
a bit stream input step of inputting a bit stream obtained by encoding a frequency domain signal converted from a time domain signal;
a bit stream decomposing step of analyzing a signal received from said bit stream input unit and of decoding bit stream information;
a bit stream information storing step of temporarily storing the bit stream information obtained through said bit stream decomposing step;
an inverse quantizing step of generating a frequency spectral signal in a predetermined frequency band in accordance with the bit stream information in said bit stream information storing step;
a spectral expanding step of outputting an expanded spectrum generated by adding a frequency spectrum in a band higher than said predetermined frequency band to a frequency spectrum outputted from said inverse quantizing step;
an external frequency information inputting step of retrieving information of a sampling frequency of the bit stream from the bit stream information in said bit stream information storing step to determine a sampling frequency intended to be decoded; and
a frequency-time domain converting step of converting frequency spectral data outputted from said spectral expanding step into a time domain signal in accordance with a sampling frequency received from said external frequency information inputting step.
